(19) United States
(12) Patent Application Publication
(10) Pub. No.: US 2007/0224464 A1
(43) Pub. Date: Sep. 27, 2007

(54) Dye-sensitized photovoltaic cells

(76) Inventors: Srini Balasubramanian, Westford, MA (US); Keith Brooks, Leysin (CH)

Correspondence Address: Konarka Technologies, Inc., Suite 12, 116 John Street, Lowell, MA, 01852, US

(21) Appl. No.: 11/377,967

(22) Filed: Mar. 17, 2006

Related U.S. Application Data
(60) Provisional application No. 60/664,265, filed on Mar. 21, 2005.

(51) Int. Cl. H01M 8/00

(52) U.S. Cl. 429/13

(57) ABSTRACT

Dye-sensitized photovoltaic cells, as well as related modules, are disclosed.

### CROSS REFERENCE TO RELATED APPLICATION

Pursuant to 35 U.S.C. § 119(e), this application claims priority to U.S. Provisional Application Ser. No. 60/664,265, filed Mar. 21, 2005, the contents of which are hereby incorporated by reference.

### TECHNICAL FIELD

This disclosure relates to dye-sensitized photovoltaic cells, as well as related modules.

### BACKGROUND

Photovoltaic cells can convert light, such as sunlight, into electrical energy. One type of photovoltaic cell is commonly referred to as dye-sensitized photovoltaic cell.

### SUMMARY

This disclosure relates to dye-sensitized photovoltaic cells, as well as related modules.

In one aspect, this invention features a photovoltaic cell that includes a first electrode, a photoactive material, and a second electrode between the first electrode and the photoactive material. The first and second electrodes and the photoactive material are configured to form the photovoltaic cell.

In another aspect, this invention features a photovoltaic cell that includes first and second electrodes, a photoactive material, and an electrical insulator between the first and second electrodes. The electrical insulator has a plurality of open regions. The first and second electrodes, the photoactive material, and the electrical insulator are configured to form the photovoltaic cell.

In another aspect, this invention features a photovoltaic cell that includes first and second electrodes and a photoactive material. The second electrode includes a plurality of open regions that have at most about 80% of a total surface area of the second electrode.

In another aspect, this invention features a photovoltaic cell that includes first and second electrodes and a photoactive material. The second electrode includes a plurality of open regions, each of which has an area of at most about 500 μm².

In still another aspect, this invention features a module that includes a plurality of photovoltaic cells (e.g., one or more of the forgoing photovoltaic cells). At least some of the photovoltaic cells are electrically connected (e.g., some of the cells are connected in series and/or some of the cells are connected in parallel).

Embodiments can include one or more of the following features.

The first electrode can be a cathode and/or can be formed of a metal, such as titanium, stainless steel, palladium, platinum, copper, aluminum, indium, gold, or an alloy thereof. The first electrode can have a total resistance of at most about 1Ω/square.

The second electrode can be an anode and/or can also be formed of a metal, such as titanium, stainless steel, copper, aluminum, indium, gold, or an alloy thereof. The second electrode can have a total resistance of at most about 1Ω/square. The second electrode can contain a plurality of open regions (e.g., circular openings having an average diameter of at most about 25 μm and/or each circular opening having a diameter at most about 25 μm).

The photovactive material can contain a semiconductor material (e.g., semiconductor nanoparticles). The photoactive material can also contain a dye and/or an electrolyte.

The photovoltaic cell can include a catalyst between the first and second electrodes. Examples of suitable catalysts include platinum, a polythiophene, a polypyrrole, a polyaniline, or a combination thereof. The catalyst can be in communication with the photoactive material through the open regions in the second electrode.

The photovoltaic cell can include an electrical insulator between the first and second electrodes. The electrical insulator can be formed of a porous material. Examples of suitable materials for use as the electrical insulator include a polytetrafluoroethylene, a polyethylene, an inorganic oxide, or a combination thereof. The electrical insulator can be disposed between the catalyst and the second electrode.

The photovoltaic cell can be a dye-sensitized photovoltaic cell.

Embodiments can provide one or more of the following advantages.

In some embodiments, both the anode and the cathode can be made from non-transparent materials, such as metals, because the incident light can reach the photoactive material without first passing through an electrode. Metal electrodes generally have significantly lower electrical resistance than non-metal electrodes. As a result, such a photovoltaic cell can be substantially much more efficient at converting light into electrical energy than a photovoltaic cell containing no metal electrode or one metal electrode. Further, because the incident light may not be absorbed by any electrode before it reaches the photoactive material, the efficiency of the photovoltaic cell can be relatively high.

In some embodiments, using two metal electrodes allows the preparation of a photovoltaic cell having a larger width and a smaller percentage of inactive areas (e.g., the areas that contain no photoactive materials and are used to connect photovoltaic cells to form a module), which can result in relatively high efficiency. Photovoltaic modules containing such photovoltaic cells also have a smaller percentage inactive areas, and therefore can have relatively high efficiency.

In some embodiments, a photovoltaic cell having two metal electrodes can be substantially devoid of a glass substrate. This can reduce the total weight of the cell. In such embodiments, the photovoltaic cell can contain flexible substrates, which can assist in making the photovoltaic cell and is suitable for use in a large variety of applications. Further, a photovoltaic cell having flexible substrates can be readily manufactured on a large scale (e.g., by a roll-to-roll process).

In some embodiments, a photovoltaic cell having two metal electrodes can be substantially devoid of a transparent conductive oxide (e.g., indium tin oxide) layer. This can reduce the cost associated with manufacturing the photovoltaic cell.

Other features and advantages of the invention will be apparent from the description, drawings, and claims.

### DESCRIPTION OF DRAWINGS

FIG. 1 is a cross-sectional view of a photovoltaic cell having two metal electrodes.

FIG. 2 is a top view of an anode in a photovoltaic cell.

FIG. 3 is a cross-sectional view of a module in which two photovoltaic cells are connected in series.

Like reference symbols in the various drawings indicate like elements.

### DETAILED DESCRIPTION

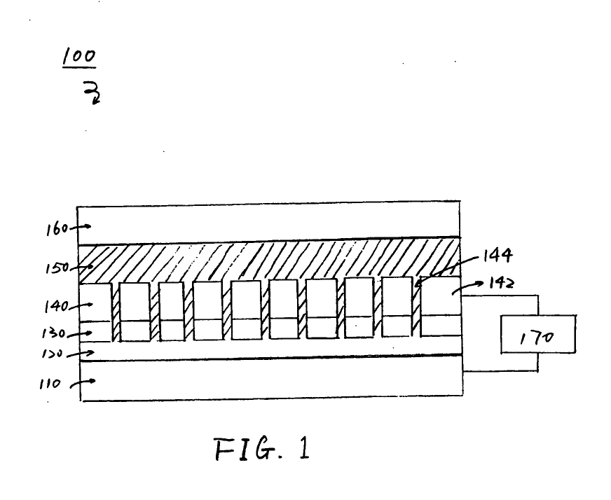

FIG. 1 shows a cross-sectional view of a photovoltaic cell 100 that includes a cathode 110, a catalyst layer 120, an insulating layer 130, an anode 140, a photoactive layer 150, and an substrate 160. Photoactive layer 150 contains a semiconductor material (e.g., TiO₂ particles), a photosensitizing agent (e.g., a dye) associated with the semiconductor material, and an electrolyte (e.g., an iodide/iodine solution). Anode 140 includes solid regions 142 and open regions 144, which contain an electrolyte. Catalyst layer 120 is in communication with photoactive layer 150 through open regions 144.

In general, during use, light passes through substrate 160 and excites the photosensitizing agent in photoactive layer 150. The excited photosensitizing agent then injects electrons into the conduction band of the semiconductor material in photoactive layer 150, which leaves the photosensitizing agent oxidized. The injected electrons flow through the semiconductor material, to anode 140, then to an external load 170. After flowing through the external load 170, the electrons flow to cathode 110, then to catalyst layer 120, where the electrons reduce the electrolyte in open regions 145 at the interface between photoactive layer 150 and catalyst layer 120. The reduced electrolyte can then reduce the oxidized photosensitizing agent molecules in photoactive layer 150 back to their neutral state. The electrolyte can act as a redox mediator to control the flow of electrons from cathode 110 to anode 140. This cycle of excitation, oxidation, and reduction is repeated to provide continuous electrical energy to external load 170.

In general, anode 140 is formed of an electrically conductive material. In some embodiments, anode 140 can be formed of a continuous layer of a metal, such as titanium, stainless steel, palladium, platinum, copper, aluminum, indium, gold, or an alloy thereof. In some embodiments, anode 140 can be between about 5 μm to about 100 μm thick (e.g., between about 10 μm to about 50 μm thick or between about 12 μm to about 25 μm thick). For example, anode 140 can be 30 μm thick. In some embodiments, anode 140 can have a total resistance of at most about 10Ω/square (e.g., at most about 1Ω/square, at most about 0.1Ω/square, or at most about 0.01Ω/square).

In some embodiments, anode 140 is formed of a non-transparent material, which transmits, for example, less than about 10% of the incident energy at a wavelength or a range of wavelengths (e.g., the visible light spectrum) used during operation of a photovoltaic cell. Examples of non-transparent materials suitable for forming such anode include certain metals. In certain embodiments, anode 140 is formed of a transparent material, which transmits, for example, at least about 60% (e.g., at least about 70%, at least about 75%, at least about 80%, or at least about 85%) of incident energy at a wavelength or a range of wavelengths (e.g., the visible light spectrum) used during operation of a photovoltaic cell. Examples of transparent materials suitable for forming such anode include certain metal oxide, such as indium tin oxide, tin oxide, or a fluorine-doped tin oxide.

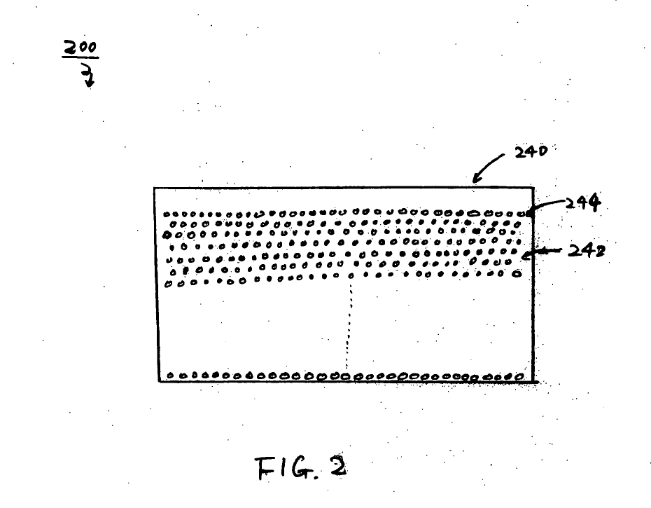

As shown in FIG. 2, an anode 240 includes solid regions 242 and open regions 244, through which a catalyst is in communication with an active layer. The area of anode 240 occupied by open regions 244 can vary as desired. Generally, open regions 244 can have an area of at most about 80% (e.g., at most about 70%, at most about 60%, at most about 50%, at most about 40%, at most about 30%, at most about 20%, or at most about 10%) of a total surface area of anode 240. In some embodiments, each open region 244 can have an area of at most about 500 μm² (e.g., at most about 200 μm², at most about 100 μm², at most about 50 μm², or at most about 20 μm²). Open regions 244 can generally have any desired shape (e.g., square, rectangle, circle, semicircle, triangle, diamond, ellipse, trapezoid, or a irregular shape). In some embodiments, different open regions 244 in anode 240 can have different shapes.

In embodiments where open regions 244 are circular openings, the diameter of each circular opening can be at most about 150 μm (e.g., at most about 100 μm, at most about 50 μm, at most about 10 μm, or at most about 5 μm). In some embodiments, the average diameter of the circular openings can be at most about 25 μm (e.g., at most about 20 μm, at most about 15 μm, at most about 10 μm, or at most about 5 μm). The distance from the center of a circular opening to the center of a neighboring circular opening can be at most about 150 μm (e.g., at most about 100 μm, at most about 50 μm, at most about 10 μm, or at most about 5 μm). For example, the distance from the center of a circular opening to the center of a neighboring circular opening can be about 15 μm.

Referring to FIG. 1, open regions 144 generally include an electrolyte, such as I₃₋/I⁻. In some embodiments, the electrolyte in open regions 144 is the same as the electrolyte in photoactive layer 150. During operation, the electrolyte in open regions 144 is reduced. The reduced electrolyte can then reduce the oxidized photosensitizing agent molecules in photoactive layer 150 back to their neutral state. In certain embodiments, open regions 144 can also include a semiconductor material (e.g., TiO₂ nanoparticles) and/or a photosensitizing agent (e.g., a dye).

The method of preparing an anode that contains a plurality of open regions can vary as desired depending upon, for example, the size and shape of the open regions. Examples of suitable methods include laser ablation methods, mechanical methods, photochemical machining methods, and metallurgical methods. For example, a laser ablation method can include exposing a foil to UV laser through a mask with a desired pattern. The laser ablates the foil, thereby resulting in the desired pattern on the foil. As another example, a mechanical method can include punching pores in a metal foil and stretching the foil to open up the pores. The pore dimensions and shape can be controlled by the stretching process. As another example, a photochemical machining method can include coating a photoresist material to an metal foil to be used as an anode, exposing the coated foil under irradiation through an optical mask, removing the unexposed photoresist material, and then chemically etching the foil in the areas where the photoresist material has been removed.

The material used to form cathode 110 is generally selected based on desired electrical conductivity, optical properties, and/or mechanical properties. In some embodiments, cathode 110 can be formed of an electrically conductive material. Examples of suitable electrically conductive materials include certain metals, such as titanium, stainless steel, palladium, platinum, copper, aluminum, indium, gold, and an alloy thereof.

In some embodiments, the thickness of cathode 110 can be identical or similar to that of anode 140. For example, the thickness of cathode 110 can be between about 5 μm to about 100 μm (e.g., between about 10 μm to about 50 μm or between about 12 μm to about 25 μm).

In certain embodiments, cathode 110 can have a total resistance of at most about 10Ω/square (e.g., at most about 1Ω/square, at most about 0.1Ω/square, or at most about 0.01Ω/square). In some embodiments, the resistance of cathode 110 can be identical or similar to that of anode 140.

In some embodiments, cathode 110 is formed of a non-transparent material. Examples of non-transparent materials suitable for forming such cathode include certain metals. In certain embodiments, cathode 110 is formed of a transparent material. Examples of transparent materials suitable for forming such cathode include certain metal oxide, such as indium tin oxide, tin oxide, or a fluorine-doped tin oxide.

In some embodiments, cathode 110 can include a discontinuous layer of a conductive material. For example, cathode 110 can include an electrically conducting mesh. Photovoltaic cells having mesh electrodes are disclosed, for example, in co-pending and commonly owned U.S. Utility application Ser. Nos. 10/395,823, 10/723,554, and 10/494,560, each of which is hereby incorporated by reference.

In some embodiments, cathode 110 is flexible (e.g., sufficiently flexible to be incorporated in photovoltaic cell 100 using a continuous, roll-to-roll manufacturing process). In certain embodiments, cathode 110 is semi-rigid or inflexible. In some embodiments, different regions of cathode 110 can have a different degree of flexibility (e.g., one or more regions being flexible and one or more different regions being semi-rigid or inflexible).

While FIG. 1 does not show that cathode 110 is supported by a substrate, in some embodiments, cathode 110 can be placed on a substrate. The substrate can be formed from a mechanically-flexible material (e.g., a flexible polymer) or a rigid material (e.g., glass). Examples of polymers that can be used to form a flexible substrate include polyethylene naphthalates, polyethylene terephthalates, polyethyelenes, polypropylenes, polyamides, polymethylmethacrylate, polycarbonate, and/or polyurethanes. Flexible substrates can facilitate continuous manufacturing processes such as web-based coating and lamination. The thickness of the substrate can vary as desired. Typically, substrate thickness and type are selected to provide mechanical support sufficient for a photovoltaic cell to withstand the rigors of manufacturing, deployment, and use. The substrate can have a thickness of about 6 microns to about 5,000 microns (e.g., from about 6 microns to about 50 microns, from about 50 microns to about 5,000 microns, from about 100 microns to about 1,000 microns). The substrate can be formed from a transparent material or an opaque material.

Catalyst layer 120 is generally formed of a material that can catalyze a redox reaction in the photoactive layer 150. Examples of materials from which catalyst layer 120 can be formed include platinum and polymers, such as polythiophenes, polypyrroles, polyanilines and their derivatives. Examples of polythiophene derivatives include poly(3,4-ethylenedioxythiophene), poly(3-butylthiophene), poly[3-(4-octylphenyl)thiophene], poly(thieno[3,4-b]thiophene), and poly(thieno[3,4-b]thiophene-co-3,4-ethylenedioxythiophene). Catalyst layers containing one or more polymers are disclosed, for example, in co-pending and commonly owned U.S. Utility application Ser. No. 10/897,268 and U.S. Provisional Application 60/637,844, both of which are hereby incorporated by reference.

In embodiments where catalyst layer 120 contains platinum, the platinum can be applied onto cathode 110 by, for example, screen printing. In embodiments where catalyst layer 120 contains a polymer, the polymer can be electrochemically deposited on cathode 110. Methods of electrochemical deposition are described in, for example, “Fundamentals of Electrochemical Deposition,” by Milan Paunovic and Mordechay Schlesinger (Wiley-Interscience; November 1998), which is incorporated herein by reference. The polymer can also be coated on cathode 110 by using a suitable coating method, such as spin coating, dip coating, knife coating, bar coating, spray coating, roller coating, slot coating, gravure coating, screen printing, and/or ink-jetting.

In general, insulating layer 130 is formed of an electrical insulator and is disposed between cathode 110 and anode 140. In some embodiments, the electrical insulator can be formed of a material having a high resistance. For example, the electrical insulator can be made of an organic material or an inorganic material. Suitable organic materials include polytetrafluoroethylene, polyethylene and polystyrene. Suitable inorganic materials include oxides (e.g., SiO₂, ZrO₂, and TiO₂), organometallic compounds (e.g., tetraethylorthosilicate), and inorganic polymers (e.g., polydimethylsiloxane). As an example, the electrical insulator can be formed of a mixture containing nanoparticles of SiO₂ and TiO₂, and a silicon-containing compound (e.g., tetraethylorthosilicate or polydimethylsiloxane). In certain embodiments, the electrical insulator is formed of spherical particles (e.g., polystyrene latex spherical particles). In certain embodiments, the electrical insulator is formed of inorganic nanoparticles.

In some embodiments, the electrical insulator can be made of a porous material, such as a porous polymer or a porous oxide. The porosity of the porous material can be at least about 50% (e.g., at least about 60%, at least about 70%, at least about 80%, or at least about 90%). The diameter of the pores can be at most about 1,000 nm (e.g., at most about 500 nm, at most about 200 nm, or at most about 100 nm) or at least about 5 nm (e.g., at least about 10 nm, at least about 20 nm, or at least about 25 nm). In some embodiments, the pores of the electrical insulator can be filled with an electrolyte to facilitate electron transfer between the electrodes of a photovoltaic cell.

In some embodiments, insulating layer 130 contain open regions that are substantially registered with the open regions in anode 140.

In some embodiments, insulating layer 130 has a thickness of at most about 20 μm (e.g., at most about 15 μm, at most about 10 μm, at most about 5 μm, or at most about 1 μm). Without wishing to be bound by theory, it is believed that insulating layer 130 having a smaller thickness decreases the diffusion path length of the electrolyte in photoactive layer 150, thereby increasing the maximum achievable current and enhancing the efficiency of a photovoltaic cell.

In some embodiments, insulating layer 130 can be disposed between anode 140 and catalyst layer 120. For example, it can be applied onto the surface of anode 140 that faces catalyst layer 120. Insulating layer 130 can be applied using a suitable coating method, such as spin coating, dip coating, knife coating, bar coating, spray coating, roller coating, slot coating, gravure coating, screen printing, and/or ink-jetting. Coating methods can be used in both continuous and batch modes of manufacturing. Without wishing to be bound by theory, it is believed that an insulating layer made from an inorganic material is preferred since such an insulating layer can be made very thin, and the methods of preparing such a layer (e.g., slot coating) are amenable to roll-to-roll production. In certain embodiments, insulating layer 130 can be applied onto the surface of catalyst layer 120 that faces anode 140.

Photoactive layer 150 generally includes a semiconductor material, a photosensitizing agent associated with the semiconductor material, and an electrolyte.

Examples of the semiconductor materials include materials of the formula MₓO_{y}, where M may be, for example, titanium, zinc, zirconium, tungsten, niobium, lanthanum, tantalum, terbium, or tin, and x and y are integers greater than zero. Other suitable materials include sulfides, selenides, tellurides, and oxides (e.g., oxides of titanium, zinc, zirconium, tungsten, niobium, lanthanum, tantalum, terbium, or tin), or combinations thereof. For example, TiO₂, SrTiO₃, CaTiO₃, ZrO₂, WO₃, La₂O₃, Nb₂O₅, SnO₂, sodium titanate, cadmium selenide (CdSe), cadmium sulphides, and potassium niobate may be suitable semiconductor materials.

Typically, the semiconductor material contained within photoactive layer 150 is in the form of nanoparticles. In some embodiments, photoactive layer 150 includes nanoparticles with an average size between about 2 nm and about 100 nm (e.g., between about 10 nm and about 40 nm, such as about 20 nm). The nanoparticles can be interconnected, for example, by high temperature sintering, or by a reactive polymeric linking agent, such as poly(n-butyl titanate). A polymeric linking agent can enable the fabrication of an interconnected nanoparticle layer at relatively low temperatures (e.g., less than about 300° C.) and in some embodiments at room temperature. The relatively low temperature interconnection process may be amenable to continuous manufacturing processes using polymer substrates.

In some embodiments, photoactive layer 150 can be formed of a porous material. The porosity of the porous material can be at least about 40% (e.g., at least about 50%, at least about 60%, or at least about 70%) or at most about 95% (e.g., at most about 90% or at most about 80%). The diameter of the pores can be at most about 1,000 nm (e.g., at most about 500 nm or at most about 100 nm) or at least about 1 nm (e.g., at least about 5 nm, at least about 10 nm, or at least about 50 nm). In certain embodiments, the pores are randomly distributed in photoactive layer 150.

In some embodiments, photoactive layer 150 can further includes macroparticles of the semiconductor material, where at least some of the semiconductor macroparticles are chemically bonded to each other, and at least some of the semiconductor nanoparticles are bonded to semiconductor macroparticles. The photosensitizing agent is sorbed (e.g., chemisorbed and/or physisorbed) on the semiconductor material. Macroparticles refers to a collection of particles having an average particle size of at least about 100 nanometers (e.g., at least about 150 nanometers, at least about 200 nanometers, at least about 250 nanometers). Examples of photovoltaic cells including macroparticles in the photoactive layer are disclosed, for example, in co-pending and commonly owned U.S. Provisional Application 60/589,423, which is hereby incorporated by reference.

The photosensitizing agent may include, for example, one or more dyes containing functional groups, such as carboxyl and/or hydroxyl groups, that can chelate to the semiconductor material, e.g., to Ti(IV) sites on a TiO₂ surface. Exemplary dyes include anthocyanines, porphyrins, phthalocyanines, merocyanines, cyanines, squarates, eosins, and metal-containing dyes such as cis-bis(isothiocyanato)bis(2,2′-bipyridyl-4,4′-dicarboxylato)-ruthenium (II), tris(isothiocyanato)-ruthenium (II)-2,2′:6′,2″-terpyridene-4,4′,4″-tricarboxylic acid, cis-bis(isothiocyanato)bis(2,2′-bipyridyl-4,4′-dicarboxylato) ruthenium (II) bis-tetrabutylammonium, cis-bis(isocyanato) (2,2′-bipyridyl-4,4′ dicarboxylato) ruthenium (II), and tris(2,2′-bipyridyl-4,4′-dicarboxylato) ruthenium (II) dichloride, all of which are available from Solaronix.

In embodiments where the semiconductor material is in the form of interconnected nanoparticles, the interconnected nanoparticles can be photosensitized by the photosensitizing agent. The photosensitizing agent facilitates conversion of incident light into electricity to produce the desired photovoltaic effect. It is believed that the photosensitizing agent absorbs incident light resulting in the excitation of electrons in the photosensitizing agent. The energy of the excited electrons is then transferred from the excitation levels of the photosensitizing agent into a conduction band of the interconnected nanoparticles. This electron transfer results in an effective separation of charge and the desired photovoltaic effect. Accordingly, the electrons in the conduction band of the interconnected nanoparticles are made available to drive external load 170.

The photosensitizing agent can be sorbed (e.g., chemisorbed and/or physisorbed) on the nanoparticles. The photosensitizing agent is selected, for example, based on its ability to absorb photons in a wavelength range of operation (e.g., within the visible spectrum), its ability to produce free electrons (or electron holes) in a conduction band of the nanoparticles, and its effectiveness in complexing with or sorbing to the nanoparticles, and/or its color.

The electrolyte in photoactive layer 150 includes a material that facilitates the transfer of electrical charge from a ground potential or a current source to the photosensitizing agent. A general class of suitable electrolytes include solvent-based liquid electrolytes, polyelectrolytes, polymeric electrolytes, solid electrolytes, n-type and p-type transporting materials (e.g., conducting polymers), and gel electrolytes. Other choices for electrolytes are possible. For example, the electrolytes can include a lithium salt that has the formula LiX, where X is an iodide, bromide, chloride, perchlorate, thiocyanate, trifluoromethyl sulfonate, or hexafluorophosphate.

In some embodiments, the electrolyte can include a redox system. Suitable redox systems may include organic and/or inorganic redox systems. Examples of such systems include cerium(III) sulphate/cerium(IV), sodium bromide/bromine, lithium iodide/iodine, Fe²⁺/Fe³⁺, Co^{2+/Co}³⁺, and viologens. Furthermore, the electrolyte may have the formula MᵢXⱼ, where i and j are greater than or equal to one, where X is an anion, and M is lithium, copper, barium, zinc, nickel, a lanthamide, cobalt, calcium, aluminum, or magnesium. Suitable anions include chloride, perchlorate, thiocyanate, trifluoromethyl sulfonate, and hexafluorophosphate.

In some embodiments, the electrolyte includes a polymeric electrolyte. For example, the polymeric electrolyte can include poly(vinyl imidazolium halide) and lithium iodide and/or polyvinyl pyridinium salts. In certain embodiments, the electrolyte can include a solid electrolyte, such as lithium iodide, pyridimum iodide, and/or substituted imidazolium iodide.

In some embodiments, the electrolyte can include various types of polyelectrolytes. For example, suitable polyelectrolytes can include between about 5% and about 95% (e.g., 5-60%, 5-40%, or 5-20%) by weight of a polymer, e.g., an ion-conducting polymer, and about 5% to about 95% (e.g., about 35-95%, 60-95%, or 80-95%) by weight of a plasticizer, about 0.05 M to about 10 M of a redox electrolyte of organic or inorganic iodides (e.g., about 0.05-2 M, 0.05-1 M, or 0.05-0.5 M), and about 0.01 M to about 1 M (e.g., about 0.05-0.5 M, 0.05-0.2 M, or 0.05-0.1 M) of iodine. The ion-conducting polymer may include, for example, polyethylene oxide, polyacrylonitrile, polymethylmethacrylate, polyethers, and polyphenols. Examples of suitable plasticizers include ethyl carbonate, propylene carbonate, mixtures of carbonates, organic phosphates, butyrolactone, and dialkylphthalates.

In some embodiments, the electrolyte can include one or more zwitterionic compounds. In general, the zwitterionic compound(s) have the formula: 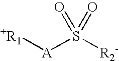
where R₁ is a cationic heterocyclic moiety, a cationic ammonium moiety, a cationic guanidinium moiety, or a cationic phosphonium moiety. R₁ can be unsubstituted or substituted (e.g., alkyl substituted, alkoxy substituted, poly(ethyleneoxy) substituted, nitrogen-substituted). Examples of cationic substituted heterocyclic moieties include cationic nitrogen-substituted heterocyclic moieties (e.g., alkyl imidazolium, piperidinium, pyridinium, morpholinium, pyrimidinium, pyridazinium, pyrazinium, pyrazolium, pyrrolinium, thiazolium, oxazolium, triazolium). Examples of cationic substituted ammonium moieties include cationic alkyl substituted ammonium moieties (e.g., symmetric tetraalkylammonium). Examples of cationic substituted guanidinium moieties include cationic alkyl substituted guanidinium moieties (e.g., pentalkyl guanidinium. R₂ is an anoinic moiety that can be: 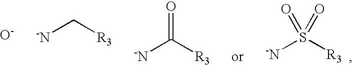
where R₃ is H or a carbon-containing moiety selected from Cₓ alkyl, Cₓ₊₁, alkenyl, Cₓ₊₁ alkynyl, cycloalkyl, heterocyclyl and aryl; and x is at least 1 (e.g., two, three, four, five, six, seven, eight, nine, 10, 11, 12, 13, 14, 15, 16, 17, 18, 19, 20). In some embodiments, a carbon-containing moiety can be substituted (e.g., halo substituted). A is (C(R₃)₂)ₙ, where: n is zero or greater (e.g., one, two, three, four, five, six, seven, eight, nine, 10, 11, 12, 13, 14, 15, 16, 17, 18, 19, 20); and each R₃ is independently as described above. Electrolytes including one or more zwitterionic compounds are disclosed, for example, in co-pending and commonly owned U.S. Utility application Ser. No. 11/000,276, which is hereby incorporated by reference.

Although the semiconductor material, the photosensitizing agent, and the electrolyte are interspersed in one layer in the foregoing embodiments, in some embodiments these materials may be disposed in different layers.

Substrate 160 generally encapsulates photoactive layer 150. In some embodiments, substrate 160 is transparent. Substrate 160 can be formed from a mechanically-flexible material (e.g., a flexible polymer) or a rigid material (e.g., glass). Examples of polymers that can be used to form a flexible substrate include polyethylene naphthalates, polyethylene terephthalates, polyethyelenes, polypropylenes, polyamides, polymethylmethacrylate, polycarbonate, and/or polyurethanes. The substrate can have a thickness of about 50 to 5,000 microns, such as, about 100 to 1,000 microns.

Photovoltaic cell 100 can provide relatively efficient conversion of incident light into electrical energy. For example, photovoltaic cell 100 may exhibit efficiencies more than about one percent (e.g., more than about two percent, three percent, four percent, five percent, eight percent, such as ten percent or more) as measured under the sun at AM 1.5 global irradiation.

An exemplary method of preparing photovoltaic cell 100 is described below. A cathode is prepared from a metal foil (e.g., a titanium foil or a stainless steel foil). One side of the metal foil is coated with a catalytic material (e.g., platinum). An anode is prepared by generating a large number of small circular holes on another metal foil (e.g., a titanium foil or a stainless steel foil) in the area to be used as the active area of the finished photovoltaic cell. A porous semiconductor (e.g., TiO₂) film is then deposited onto one side of the anode containing the holes, dried, and sintered. The semiconductor film is subsequently sensitized with a photosensitizing agent (e.g., a Ru-based dye). A porous insulating layer (e.g., a porous polymer) is then placed between the side of the cathode coated with the catalytic material and the uncoated side of the anode. A transparent polymer is placed on the coated side of the anode to encapsulate the semiconductor material and the photosensitizing agent. An electrolyte is then infiltrated into the porous semiconductor material, the holes in the anode, and the porous insulating layer to form a photovoltaic cell.

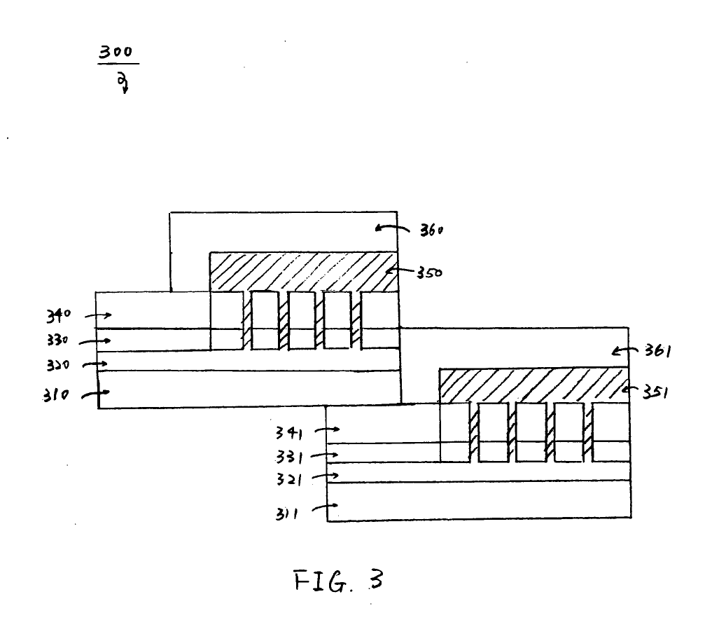

This disclosure also includes a photovoltaic module that includes a plurality of photovoltaic cells, at least some of which are electrically connected. FIG. 3 describes an embodiment of such a module in which two photovoltaic cells are connected in series. As shown in FIG. 3, cathode 310 of one photovoltaic cell is in electrical connection with anode 341 of the other photovoltaic cell.

The photovoltaic module can generally be used as a component in any intended systems. Examples of such systems include roofing, package labeling, battery chargers, sensors, window shades and blinds, awnings, opaque or semitransparent windows, and exterior wall panels.

Other embodiments are in the claims.

What is claimed is:

1. A photovoltaic cell, comprising:
a first electrode;
a photoactive material; and
a second electrode between the first electrode and the photoactive material;
wherein the first and second electrodes and the photoactive material are configured to form the photovoltaic cell.

2. The photovoltaic cell of claim 1, wherein the second electrode comprises a metal.

3. The photovoltaic cell of claim 2, wherein the metal comprises titanium, stainless steel, palladium, platinum, copper, aluminum, indium, gold, or an alloy thereof.

4. The photovoltaic cell of claim 1, wherein the second electrode has a total resistance of at most about 1Ω/square.

5. The photovoltaic cell of claim 1, wherein the second electrode comprises a plurality of open regions.

6. The photovoltaic cell of claim 5, wherein the open regions comprise at most about 80% of a total surface area of the second electrode.

7. The photovoltaic cell of claim 5, wherein each open region has an area of at most about 500 μm².

8. The photovoltaic cell of claim 5, wherein the open regions are circular openings.

9. The photovoltaic cell of claim 8, wherein each circular opening has a diameter of at most about 25 μm.

10. The photovoltaic cell of claim 8, wherein the circular openings have an average diameter of at most about 25 μm.

11. The photovoltaic cell of claim 1, further comprising a catalyst between the first and second electrodes.

12. The photovoltaic cell of claim 11, wherein the catalyst is in communication with the photoactive material through a plurality of open regions in the second electrode.

13. The photovoltaic cell of claim 11, wherein the catalyst comprises platinum, a polythiophene, a polypyrrole, a polyaniline, or a combination thereof.

14. The photovoltaic cell of claim 1, further comprising an electrical insulator between the first and second electrodes.

15. The photovoltaic cell of claim 14, wherein the electrical insulator is disposed between the catalyst and the second electrode.

16. The photovoltaic cell of claim 14, wherein the electrical insulator comprises a porous material.

17. The photovoltaic cell of claim 14, wherein the electrical insulator comprises a polytetrafluoroethylene, a polyethylene, an inorganic oxide, or a combination thereof.

18. The photovoltaic cell of claim 14, wherein the electrical insulator comprises a plurality of open regions that are substantially registered with a plurality of open regions in the second electrode.

19. The photovoltaic cell of claim 1, wherein the photoactive material comprises a semiconductor material.

20. The photovoltaic cell of claim 19, wherein the semiconductor material comprises nanoparticles.

21. The photovoltaic cell of claim 19, wherein the photoactive material further comprises a dye.

22. The photovoltaic cell of claim 1, wherein the photoactive material comprises an electrolyte.

23. The photovoltaic cell of claim 1, wherein the photovoltaic cell is a dye-sensitized photovoltaic cell.

24. The photovoltaic cell of claim 1, wherein the second electrode is an anode.

25. The photovoltaic cell of claim 1, wherein the first electrode comprises a metal.

26. The photovoltaic cell of claim 25, wherein the metal comprises titanium, stainless steel, palladium, platinum, copper, aluminum, indium, gold, or an alloy thereof.

27. The photovoltaic cell of claim 25, wherein the first electrode has a total resistance of at most about 1Ω/square.

28. The photovoltaic cell of claim 1, wherein the first electrode is a cathode.

29. A module, comprising a plurality of the photovoltaic cells of claim 1, at least some of the photovoltaic cells being electrically connected.

30. The module of claim 29, wherein at least some of the cells are connected in series.

31. The module of claim 29, wherein at least some of the cells are connected in parallel.

32. A photovoltaic cell, comprising
first and second electrodes;
a photoactive material; and
an electrical insulator between the first and second electrodes, the electrical insulator having a plurality of open regions;
wherein the first and second electrodes, the photoactive material, and the electrical insulator are configured to form the photoactive cell.

33. The photovoltaic cell of claim 32, wherein the electrical insulator comprises a porous material.

34. The photovoltaic cell of claim 32, wherein the electrical insulator comprises a polytetrafluoroethylene, a polyethylene, a metal oxide, or a combination thereof.

35. The photovoltaic cell of claim 32, wherein the plurality of open regions in the electrical insulator are substantially registered with a plurality of open regions in the second electrode.

36. A photovoltaic cell, comprising
first and second electrodes; and
a photoactive material;
wherein the second electrode comprises a plurality of open regions that are at most about 80% of a total surface area of the second electrode, and the first and second electrodes and the photoactive material are configured to form the photovoltaic cell.

37. A photovoltaic cell, comprising
first and second electrodes; and
a photoactive material;
wherein the second electrode comprises a plurality of open regions, each of which has an area of at most about 500 μm², and the first and second electrodes and the photoactive material are configured to form the photovoltaic cell.
